(19) United States
(12) Patent Application Publication
(10) Pub. No.: US 2011/0146587 A1
(43) Pub. Date: Jun. 23, 2011

(54) APPARATUS FOR ENVIRONMENTAL ENRICHMENT OF MONKEYS

(75) Inventor: Jacqnene A. Howard, Delancey, NY (US)

(73) Assignee: THE RESEARCH FOUNDATION OF STATE UNIVERSITY OF NEW, Albany, NY (US)

(21) Appl. No.: 12/992,345

(22) PCT Filed: May 12, 2009
(86) PCT No.: PCT/US2009/043583

§ 371 Date: Mar. 11, 2011

Related U.S. Application Data
(60) Provisional application No. 61/052,830, filed on May 13, 2008.

(51) Int. Cl. A01K 29/00

(52) U.S. Cl. 119/710

(57) ABSTRACT

The present invention is directed to products and methods for enrichment of animals, particularly primates which are held in captivity. In particular, the invention is directed to a device which may be presented to and manipulated by primates to foster and encourage enrichment of the primate.

### CROSS REFERENCE TO RELATED APPLICATION

The present invention is a non-provisional conversion of U.S. Patent Application Ser. No. 61/052,830, filed on May 13, 2008, the entire contents of which are incorporated herein by reference.

### FIELD OF THE INVENTION

The invention relates to a type of environmental enrichment device for monkeys, specifically, an environmental enrichment device for captive monkeys.

### BACKGROUND OF THE INVENTION

The Animal Welfare Act of 1985 mandated standards to promote the psychological well-being of laboratory primates. The USDA Draft Policy on Environmental Enhancement for Nonhuman Primates (US Department of Agriculture, 1999) specifies that environmental enhancement plans should provide for daily foraging opportunities, as in the wild, primates generally spend between 26% and 70% of their day finding, obtaining, and processing their food. Depending on the animal species and use, the structural environment should include resting boards, shelves or perches, toys, foraging devices, nesting materials, tunnels, swings, or other objects that increase opportunities for the expression of species-typical postures and activities and enhance the animals' well-being. In captivity, this time is drastically reduced to the amount of time it takes to consume the provided food. This idle time which is then available to the primates results in a decrease in natural species behaviors accompanied by a simultaneous increase in abnormal behaviors, such as pacing and hair-pulling. Foraging devices require extra manipulation by the primates, which prolongs consumption time, thereby providing mental stimulation. Research shows that such devices decrease levels of abnormal behaviors, while simulating a more natural environment and increasing environmental exploration.

Object manipulation is an important part of the primate behavioral repertoire. Providing foraging devices to captive primates assists in fostering typical manipulative behaviors, decreases abnormal behaviors, and enriches the captive environment. In particular, providing devices which require effort, thought and reasoning to primates in captivity has been found to result in significant beneficial environmental enrichment. Current devices provided to primates, however, are either too costly or fail to provide an adequate level of challenge to the primates. One example of an object currently provided to primates is referred to as the Challenger Ball®, set forth in FIG. 1. The Challenger Ball® is a plastic ball, which has a plurality of holes covering the surface, and a metal spike inserted therein to reduce the chance of objects being removed from the interior of the Challenger Ball®. Other devices which may be provided include puzzle feeders, Kongs®, mirrors, perches, balls, rocks, and various commercially available infant toys. These devices, however, suffer from various defects and fail to foster and promote adequate social interaction and enrichment in the primates.

There exists a need for a cost-effective device which solves the problems associated with previous devices, and which promotes social interaction, decreases abnormal behaviors, and fosters manipulative behaviors in primates.

### SUMMARY OF THE INVENTION

In one embodiment of the present invention, there is provided a device for enhancing environmental enrichment of primates including: a hollow head portion having at least one entry port in communication with an open interior region; and an elongated body portion having a first opening, a second opening and a hollow interior therebetween, where the first opening is in communication with the entry port. In some embodiments, the device is capable of housing an object, such as a piece of food, in the interior region of the hollow head portion.

In another embodiment, there is provided a method of enhancing environmental enrichment of primates, including the steps of: providing a device for enhancing environmental enrichment of primates, the device including: a hollow head portion having at least one entry port in communication with an open interior region; and an elongated body portion having a first opening, a second opening and a hollow interior therebetween, where the first opening is in communication with the entry port; presenting the device to at least one primate; and allowing the primate to manipulate the device. Further, the method may include the step of monitoring the manipulation of the device and/or monitoring the actions of the at least one primate.

### BRIEF DESCRIPTION OF THE FIGURES

FIG. 1 is a previously-used device referred to as the “challenger ball”.

FIG. 2 is a depiction of one embodiment of the present invention.

FIG. 2A is a cross-section of the embodiment of the present invention set forth in FIG. 2.

FIG. 3 is a graphic depiction of the results of a study conducted with the present invention.

FIG. 4 is a graphic depiction of the results of a study conducted with the present invention.

FIG. 5 is a graphic depiction of the results of a study conducted with the present invention.

FIG. 6 is a graphic depiction of the results of a study conducted with the present invention.

FIG. 7 is a graphic depiction of the results of a study conducted with the present invention.

### DETAILED DESCRIPTION OF THE INVENTION

The present invention provides a new type of enrichment and foraging device for primates, particularly primates in captivity. As used herein, the term “primates” includes monkeys, including cynomolgous monkeys, as well as apes, orangutans, lemurs, and the like. Although the studies herein are directed to primates in captivity, the devices may be utilized by primates in the wild, which may be studied by humans.

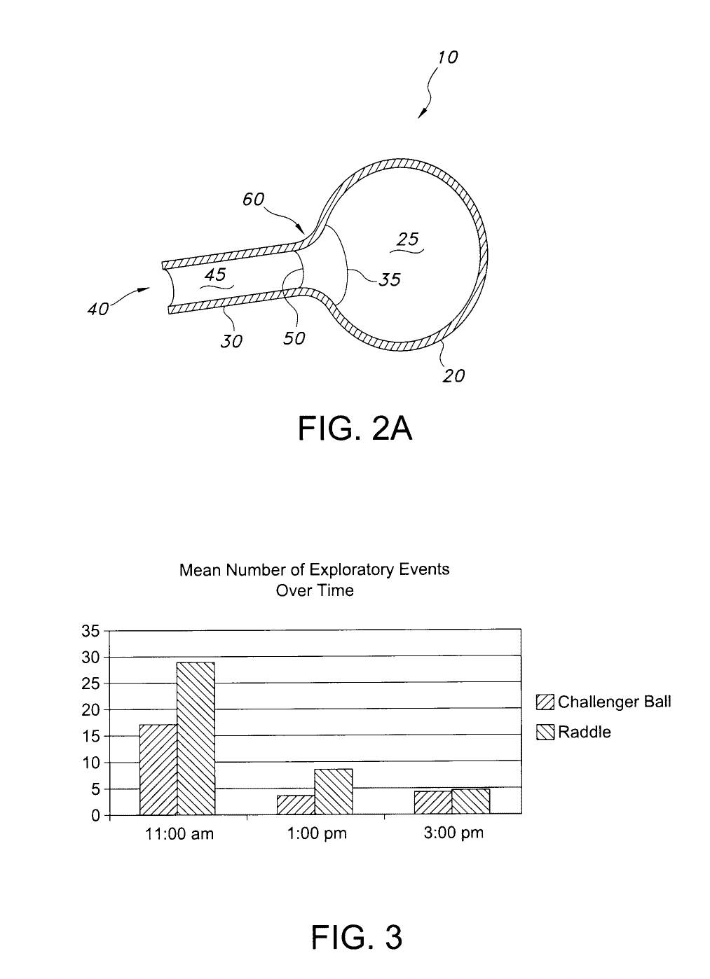

The present invention will be described with reference to FIGS. 2 and 2A. The device 10 is a generally elongated device that will be referred to as a rattle (also referred to as a “Raddle”). The device 10 includes a large head 20 and an elongated tubular body 30 extending therefrom. The head 20 and the body 30 are hollow, having an open interior 25 and 35, respectively. The head 20 has at least one entry port 35, allowing access to the interior of the head 20. The body 30 has an elongated, substantially tubular shape, having an opening 40, 50 at each end of the tubular structure. The head 20 and the body 30 are attached to each other at a joining point 60. The first opening 50 and the entry port 35 are in direct communication with each other at the joining point 60. Thus, there is open access from the interior 45 of the body 30 to the interior 25 of the head 20.

The second opening 40 of the body 30 is located at the opposite end of the body 30 from the first opening 50. The second opening 40 of the body 30 is in direct communication with the interior 45 of the body 30. Thus, an object may be inserted into the second opening 40 of the body 30 and directed through the interior 45 of the body 30, where it may then pass through the first opening 50 and the entry port 35, into the interior 25 of the head 20 of the device 10.

Any object may be inserted into the device 10. In preferred embodiments, a treat or other food material is inserted into the interior 25 of the head 20 of the device 10. Preferably, the food material is safe for consumption by primates. Also preferred are food materials that have an elongated shape, such as carrots, pepper strips, unshelled peanuts, and other elongated foods. As can be appreciated by one of skill in the art, the open space of the interior 25 of the head 20 is larger than the entry port 35 and the first opening 50. When an elongated piece of food is inserted into the interior 25 of the head 20, it will be difficult to align the elongated piece just right so that it fits through the entry port 35 and the first opening 50. Thus, the elongated piece of food will be difficult to remove from the interior 25 of the head 20 once placed therein, requiring effort and thought on the part of the primate in use.

In use, an elongated piece of food may be placed into the device 10, such that the food is trapped in the interior 25 of the head 20. The device 10 may then be provided to a primate or group of primates. When presented with the device 10, the primate is able to smell and hear the sound of food within the device 10 (and in some embodiments see the food), and will begin to attempt to remove the food from the device 10. As explained above, the use of elongated food pieces will make it difficult for the primate to remove the food from the device 10, causing the primate to use effort, thought and reason to figure out how to release food from the device 10. Even if a non-elongated piece of food is used, the primate must still align the food properly to retrieve from the interior 25 of the head 20.

The device may be any size or shape desired. For example, the body 30 of the device 10 may be longer or shorter than the cross-section of the head 20. In other embodiments, the head 20 may have a generally spherical shape, or it may have an elongated shape. The first opening 40 and second opening 50 of the body 30 may be round, oval, square, or any other desired shape.

Desirably, the device 10 is appropriately sized for particular primate to hold and manipulate in its hands. Smaller primates may be able to manipulate a smaller sized device 10, while larger primates may be able to manipulate a larger sized device 10. In some embodiments, it may be desirable to provide a smaller device to a larger primate and vice versa, to give an added challenge to the primate. The device 10 preferably has a length (as measured from the second opening 40 to the top of the head 20) of about 4 to about 12 inches. Most desirably, the device has a length (as measured from the base 40 to the top of the head 20) of about 6 to about 8 inches. Preferably, the body 30 has a length that is approximately the same as the diameter of the head 20. That is, in some embodiments, the body may have a length (as measured from first opening 50 to second opening 40) that is about 2-4 inches, and the head 20 may have a cross section that is about 2-4 inches.

The second opening 40 (at the base of the body 30) should be appropriately sized so as to allow the insertion of the object therein, but not so large that the object will be easily removed. Desirably, the second opening 40 (at the base of the body 30) is about 15 mm to about 30 mm in diameter, and most desirably is about 15 to about 20 mm in diameter. The second opening 40 (at the base of the body 30) may have a smaller radius on the inside of the body 30 and/or on the outside of the body 30 so as to reduce the likelihood of the primate breaking the device 10.

The various components of the device 10 may be made from any durable material or materials desired. It is desirable that the material or materials used be sturdy and sanitary. In one embodiment, the components of the device 10 may be constructed from plastic materials, including polycarbonate plastic materials. Other plastic materials which may be used in the construction of the device 10 include acrylics, polyesters, polycarbonates, aminoplasts, silicones, polyurethanes, rubber, and halogenated plastics. Other examples of materials which may be used include polypropylene, polyethylene, polyethylene terephthalate, polyvinylchloride, polystyrene, nylon, neoprene, and the like. Alternatively, the device 10 may be made from durable metals, if desired, including steel, iron, and aluminum. Alternatively, the device 10 may include more than one plastic and/or metal component. Further, the body 30 may be made of one material while the head 20 is made of a different material. Any combination of materials may be used as desired.

Desirably, the walls of the device 10 are about 3-5 millimeters in thickness, so as to provide the sufficient durability during use. For more durable materials, the walls may be thinner, and for less durable materials, the walls may be thicker. For stronger primates, thicker walls may be used, for example, greater than 5 millimeters thick.

Desirably, the device 10 is made of plastic and is molded into the desired shape. The device 10 may be injection molded, blow molded, or any other desired technique. The device 10 may be manufactured as a single molded unit or it may be molded in separate parts. For example, the device 10 may be manufactured in parts by forming the head 20 and the body 30 separately. In this method of forming the device 10, the head 20 may be molded as a hollow, approximately spherical object having at least one entry port 35 to allow an object to be inserted therein. The body 30 may be separately molded as a hollow tubular object, having a first opening 50 approximately the same size as the entry port 35 of the head 20. It may be desired, however, that the first opening 50 be smaller or larger than the entry port 35. The head 20 and body 30 may then be fused together, aligning the first opening 50 of the body 30 with the entry port 35 of the head 20, thus providing open access from the interior 45 of the body 30 to the interior 25 of the head 20. The two pieces may then be fused together and the flashing removed.

The device 10 may be any color or colors desired. The device 10 may be made from clear or translucent materials, or it may be opaque. In some embodiments, the device 10 may include a combination of clear and opaque materials. For example, the body 30 may be opaque while the head 20 is clear or translucent, and vice versa. The various components of the device 10 may be colored or they may simply be white. It may be desired that the head 20 be opaque so as to prevent the primate from viewing the object (or objects) contained within the head 20. Alternatively, the head 20 may be translucent or clear so as to allow the primate to view the object (or objects) contained within the head 20.

If desired, the head 20 may include a plurality of small holes in addition to the entry port 35. For example, the head 20 may have about 5 small holes (i.e., about 4 millimeters in diameter) spaced an approximately equal distance from the center of the head 20. The plurality of holes in the head 20 may be useful for cleaning the device 10 before or after use. If desired, the device 10 should be capable of withstanding heat of at least 180° F. for cleaning, such as if cleaned in a rack washer. Further, the plurality of holes in the head 20 help to allow the primate to see into the interior 25 of the head 20, allowing viewing and smelling of the food (or other object) contained therein.

The present invention relates to methods of using the device 10 to enrich the environment of primates. The device 10 may be provided to a primate or a group of primates, especially primates in captivity, to stimulate the primates' minds and allow them to perform some of the actions that primates would perform in the wild, thereby enriching the primates' lives while in captivity. As will be explained in more detail in the Examples below, primates who have been allowed to use the device 10 of the present invention have shown an increased display of affection and other beneficial behavior as compared to those animals that have been presented with either no devices or with prior devices, such as the Challenger Ball®. For example, captive primates who have been presented with the present invention have displayed reduced aggressive behaviors, i.e., hair-pulling, hair-eating, tongue rolling, gnawing at the bars of the cage, licking cage walls, smearing feces on the cage walls, and the like. In addition, captive primates who have been presented with the present invention have also shown an increase in affection.

Primates are generally held in captivity for various experimental purposes. It is important that the primates be treated with care and respect. The primates may be housed as a group of primates (i.e., two or more primates caged together), or each primate may be held in its own private area.

The device 10 may be used to stimulate the primates while housed. The user may first insert an object, such as a piece of food, into second opening 40 (located at the base of the body 30), directing the object to travel through the interior 45 of the body 30 and into the interior 25 of the head 20 of the device 10. Once it is in the interior 25 of the head 20, the object is free to move around, but will be difficult to be removed therefrom. This is especially true when an elongate object is used.

The user may then present the primate with the object-containing device 10, allowing the primate to hold, smell, move, and manipulate the device 10 as it chooses. The primate is able to hear the object as the device 10 is moved, smell the object if it has a smell (i.e., food), and if the device 10 has a plurality of holes in the head 20 or if the head 20 is made of translucent or clear material, the primate may be able to see the object in the head 20. The primate may attempt to retrieve the object from the device 10, such as by moving, shaking and otherwise manipulating the device 10. This activity allows the primate to release some of its energy and act out its natural desire to forage, thereby enriching the primate while in captivity. The user may then monitor and evaluate the behavior exhibited by the primate as it is manipulating the device 10. Any activity may be monitored, including the actions performed with respect to the device 10 itself or actions that are not directly related to the device 10 (i.e., playing, grooming, etc.).

Since the openings in the device 10 (i.e., the entry port 35 and the first and second opening 40, 50) have relatively small cross-sections, it will be difficult for the primate to remove the object contained therein, especially if the object is elongated in shape. The primate will be forced to use effort, logic and reason in its attempt to remove the object contained in the device 10. It has been found that prior art devices (such as the Challenger Ball®) are not as difficult to remove the object contained therein. Making it too easy to remove the object fails to provide the level of effort necessary to adequately enrich the primate while in captivity. Further, when the object is not easily removable from the device 10, the primate will spend more time with the device 10, attempting to remove the object contained therein. Desirably, the object is not easily removable from the device for an average time of at least 20 minutes, and more desirably for at least 40 minutes of continuous manipulation by the primate. As will be explained in more detail in the Examples below, the present invention has been found to result in higher levels of beneficial activity in primates.

Various changes and modifications can be made in the present invention. For example, the device may be used to employ various methods of enriching animal subjects with foraging behaviors, or multiple devices may be employed in a group of animal subjects in order to promote socialization, interaction, and other beneficial attributes. It is intended that all such changes and modifications come within the scope of the invention as set forth in this discussion.

The advantages of the present invention may be understood through a comparative examination of the present invention to another type of enrichment device. This comparison is detailed in the following discussion.

### Example

The foregoing Example was conducted at the Primate Colony at SUNY Delhi College of Technology. The colony included three male and six female Cynomologus Macaques, Macaca fasicularis, ranging in ages from one year to twenty-four years old. The primates were both pair and singly housed. Pairs were rotated in cage positions or into modified dog runs and some repaired occasionally if they were compatible with other conspecifics. With the exception of the juvenile female and one adult female who were born at the college, all monkeys were obtained from outside research facilities.

### Housing of the Subjects

The Primates were housed in two separate rooms both containing group three housing as recommended by Guide for the Care and Use of Laboratory Animals. All cages were equipped with a squeeze back mechanism. One room contained two stainless steel racks of two/two cages with a removable divider. The second room contained two racks of one/one cages with both the upper and lower cages providing access to runs (10 ft. 10 in. L×3 ft W×7 ft. 3 in. H and 10 ft. 10 in. L×3 ft. 3 in. W×7 ft. 3 in. H) via a tunnel attached to the back of the cage. A swing door allowed for access to the runs to be limited when necessary. All primates were provided with a minimum of two enrichment devices. Cage enrichment devices included puzzle feeders, Kongs®, mirrors, perches, balls, rocks, and various commercially available infant toys. Run enrichment devices included those listed above as well as PVC pipe tree branches, hanging PVC pipes, swings, and hanging tire pieces. Animals were rotated in and out of the runs on a regular basis as they are rotated from room to room and re-paired. The primates were housed and cared for in a manner that complied with the American Association of Laboratory Animal Sciences (AALAS) Animal Care Statement.

### The Foraging Devices Studied

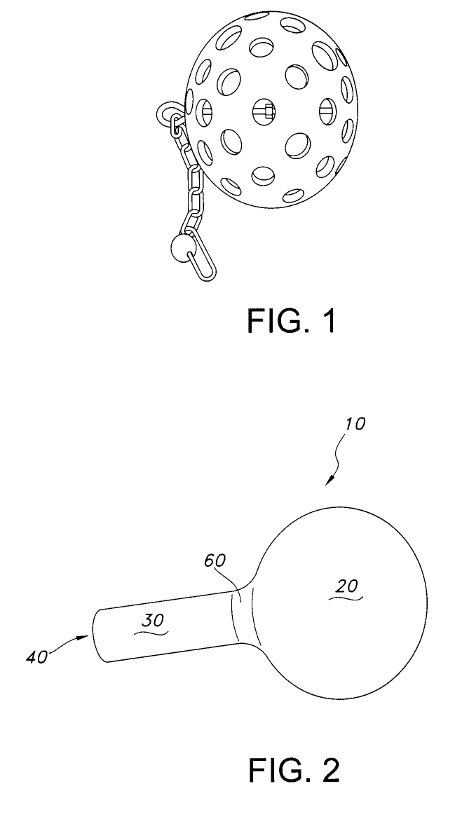

The Example provided herein was designed to compare two foraging/enrichment devices. The first device is the commercially available Challenger Ball® distributed by BioServ (set forth in FIG. 1). The second device is the present invention (set forth in FIGS. 2 and 2A). For reference, the inventive device will be referred to herein as the “Raddle”.

The Challenger Ball® is made of a Polyethylene plastic and is six inches in diameter with a removable stainless steel disk in the center. The Challenger Ball® was made to be used with Prima-Treats®, also a product of Bio-Serv. Because this study was a comparison between two different types of environmental enrichment devices, it was necessary to use treats that are compatible to each device. PrimaTreats® are made to be compatible with the Challenger Ball®; however they would not fit into the Raddle. Similarly, carrots were used in the Raddle because their shape was compatible with the body, but carrots were not used with the Challenger Ball® because they would have been too easily removed from the device, thus providing minimal enrichment. Using the same treat for both environmental enrichment devices would be difficult because of the dimensional differences between them.

The Raddle (as depicted in FIGS. 2 and 2A) was made of opaque polypropylene plastic. A 2½ inch hollow body was connected to a 2¾ inch hollow head. Peeled baby carrots were used as the treat in this study.

### Monitoring of the Test Subjects

Three times a day, three days a week direct observations were performed of the animal's interaction with the foraging devices. Information was recorded every Monday, Wednesday and Friday at 11:00 am, 1:00 pm, and 3:00 pm during the study period to avoid husbandry, feeding and Primatology laboratory classes. During these assigned hours, 10 minute direct observations were performed and recorded using tallies on ethogram sheets for each monkey, to observe the monkey's interaction with their environment, cage mate, and foraging device. Interactions were recorded as discrete events, for example each time they put their mouth to the test object a tally mark was recorded. By using the ethogram, data was collected based on several aspects of the following categories: agonistic, human directed, affiliative, non-social, exploratory (including environment and foraging device), and enrichment.

At 11:00 am the foraging devices were loaded as follows: two Prima-Treats® were put in the Challenger Ball® and two carrots were put in the Raddle. The foraging devices were then placed in the monkey's cage. A 10 minute direct observation was then performed as described above. The test objects were left in the cages and were not refilled for the 1:00 pm and 3:00 pm ethograms. At the completion of the 3:00 pm ethograms the test objects were removed from cages.

The monkeys had some limited previous experience with each object during a three week pilot study which was set up in the same manner as the actual study. It was noted that, upon initial introduction of the Raddle the primates were very destructive. Several of the original Raddles had to be removed from use because the bodies were crushed or split, not allowing for passage of the carrots. As the study progressed, less destruction was noted as the primates became acclimated with the manipulation methods necessary to obtain the carrot from the device. This demonstrates that the use of the Raddle required thought and reason on the part of the primates, which is beneficial to the enrichment of the primates.

### Results

The results were monitored and evaluated. As seen in the Table 1 below, for the average number of exploratory events recorded at 11:00 am, 1:00 pm, and 3:00 pm for both the challenger ball and the Raddle, there was a distinct decline in interest for both items as the day progresses. The results are depicted in graphical form as FIG. 3.

TABLE 1

| | | Mean | Mean |
|---|---|---|---|
| | P value | Ball | Raddle |
| 11:00 am | 0.03 | 17.31 | 28.91 |
| 1:00 pm | 0.02 | 3.68 | 8.59 |
| 3:00 pm | 0.30 | 4.24 | 4.44 |

Looking at the 11:00 am reading, there appeared to be a 67% increase in exploratory events in favor of the Raddle when comparing the challenger ball (17.30769) to the Raddle (28.90698), with a P value of 0.027982. As can be seen, at 1:00 pm there was a decrease in activity overall, but even still, there was over twice as many exploratory events for the Raddle (8.590909) as there was for the challenger ball (3.684211), with a P value of 0.02183. The 3:00 pm analysis revealed a relative stabilization in activity with a 4% increase in activity shown for the Raddle (4.444444) when compared to the challenger ball (4.236842), with a P value of 0.300595.

### Results of Exploratory Behavior

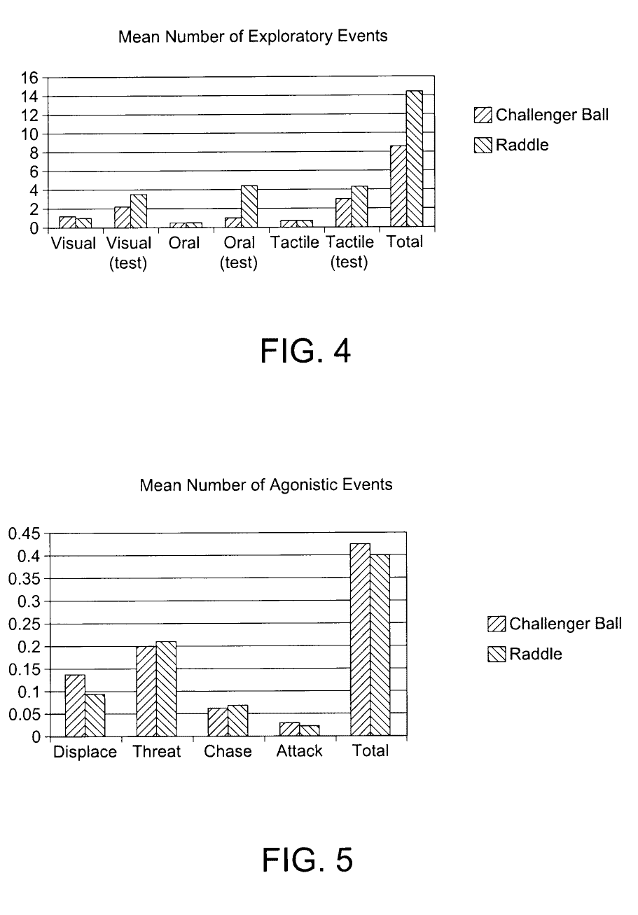

Exploratory behavior correlates with the enrichment of the animal's environment; the more things there are to explore in the environment the more activity the animal exhibits in this area. The average number of exploratory events for the Raddle was significantly greater than the average number of exploratory events for the Challenger Ball. The three categories of events that were observed were visual (the animal looks at the object), oral (the animal puts the object to their mouth), and tactile (the animal touches the object). The results are set forth in Table 2 below. The results are set forth in graphical form as FIG. 4.

TABLE 2

| | | Mean | Mean |
|---|---|---|---|
| | P value | Ball | Raddle |
| Visual | 0.30 | 1.23 | 1.08 |
| Visual (test) | 0.006 | 2.11 | 3.50 |
| Oral | 0.47 | 0.53 | 0.54 |
| Oral (test) | <0.01 | 1.04 | 4.19 |
| Tactile | 0.43 | 0.73 | 0.69 |
| Tactile (test) | 0.03 | 2.94 | 4.23 |
| Total Exploratory Events | 0.002 | 8.56 | 14.23 |

The word (test) in Table 3 differentiates observations of these behaviors which are directed at the test objects (i.e., the Challenger Ball or Raddle), as compared with other enrichment devices or surfaces in the cage environment. In the category of visual events, the average for the Raddle was 3.5 and the Challenger Ball 2.1. The average number of oral events for the Raddle was 4.1 and the Challenger Ball 1.0. The average number of tactile events for the Raddle was 4.2 and the Challenger Ball 2.9.

As can be seen, the total exploratory events—14.2 for the Raddle and 8.5 for the Challenger Ball—shows a significant statistical difference, with a noteworthy preference for the Raddle.

### Results of Agonistic Behavior

The number of Agonistic events (Displace, Threat, Chase and Attack) was measured and evaluated. The results are set forth in Table 3 below, as well as graphically displayed in FIG. 5.

TABLE 3

| | | Mean | Mean |
|---|---|---|---|
| | P value | Ball | Raddle |
| Displace | 0.19 | 0.14 | 0.09 |
| Threat | 0.46 | 0.20 | 0.21 |
| Chase | 0.42 | 0.06 | 0.07 |
| Attack | 0.46 | 0.03 | 0.02 |
| Totals | 0.42 | 0.43 | 0.40 |

The results indicated that there was no significant difference in the average number of Agonistic events (Displace, Threat, Chase and Attack) for the Raddle as compared to the Challenger Ball. This suggests that if the Raddle were placed into a cage where there was more than one monkey, agonistic behavior would not occur any more than if the Challenger Ball was placed in the same cage.

### Results of Affiliative Events

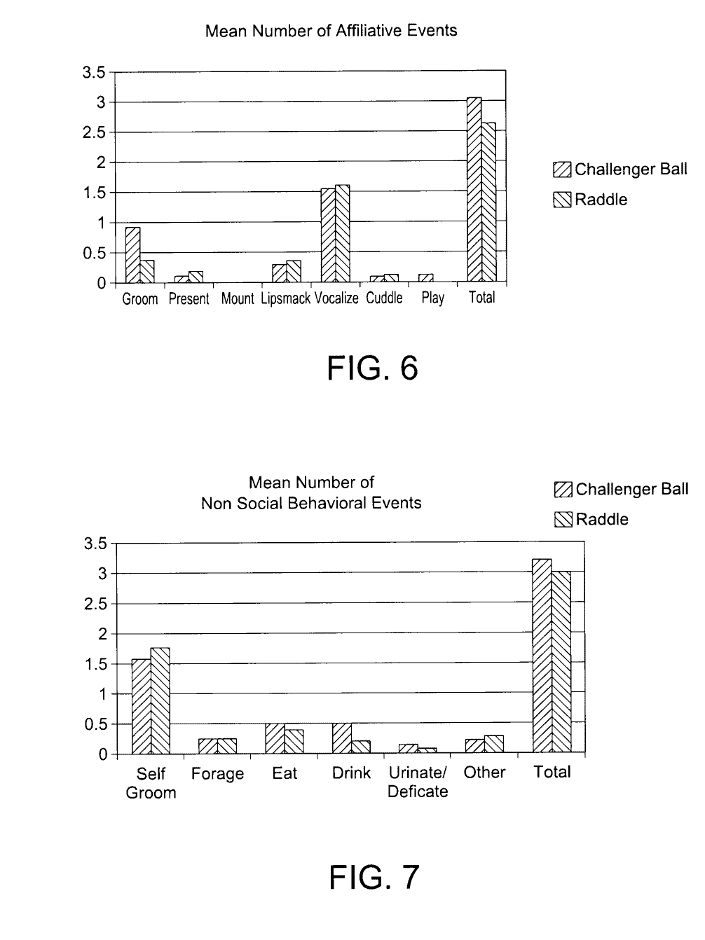

Affiliative events monitored include grooming, present, mount, lipsmack, vocalize, cuddle, and play. The results are set forth in Table 4 below, as well as graphically in FIG. 6.

TABLE 4

| | | Mean | Mean |
|---|---|---|---|
| | P value | Ball | Raddle |
| Groom | <0.01 | 0.93 | 0.37 |
| Present | 0.18 | 0.12 | 0.19 |
| Mount | 0 | 0 | 0 |
| Lipsmack | 0.28 | 0.29 | 0.35 |
| Vocalize | 0.44 | 1.54 | 1.61 |
| Cuddle | 0.38 | 0.09 | 0.11 |
| Play | 0.05 | 0.12 | 0 |
| Totals | 0.19 | 3.08 | 2.63 |

For each affiliative event except for grooming and mounting, the events statistically occurred either more frequently with the Raddle than with the Challenger Ball® or the same for both. The average number of grooming events occurred 0.929825 with the Challenger Ball® and the Raddle only had 0.372093. The average number of “presents” that occurred with the Raddle was at 0.186047 and the Challenger Ball® at 0.121739. There was no mounting that occurred with the Challenger Ball® or the Raddle. Lipsmacking was greater with the Raddle at an average of 0.348837 and Challenger Ball® was 0.286957. Vocalization was also higher with the Raddle at an average of 1.612403 and the Challenger Ball® at 1.53913. There was more cuddling between monkeys with the Raddle with an average of 0.108527 and only 0.086957 for the Challenger Ball®. There was more play between monkeys with the Challenger Ball® at an average of 0.121739 and no play with the Raddle. Of the affiliative events only grooming was statistically greater for the Challenger Ball® than the Raddle.

### Results of Non-Social Behavior

Non-social behaviors were monitored and evaluated in the study. Non social behaviors include self grooming, foraging, eating, drinking, urinating/defecating and “other” non-social behaviors. The results are set forth below in Table 5 and depicted graphically in FIG. 7.

TABLE 5

| | | Mean | Mean |
|---|---|---|---|
| | P value | Ball | Raddle |
| Self Groom | 0.18 | 1.57 | 1.78 |
| Forage | 0.42 | 0.27 | 0.25 |
| Eat | 0.13 | 0.50 | 0.36 |
| Drink | 0.01 | 0.49 | 0.20 |
| Urinate/Deficate | 0.24 | 0.13 | 0.09 |
| Other | 0.37 | 0.23 | 0.29 |
| Totals | 0.29 | 3.18 | 2.98 |

Only in the area of drinking was there a significant difference between the two devices. The subjects were seen to drink twice as often with the Challenger Ball® than with the Raddle.

### Evaluation of Results of Study

The statistical analysis of non social events showed that the primates drank twice as much when using the Challenger Ball® as compared to the Raddle. This could be related to the low moisture content (<10% moisture) of the PrimaTreats® compared to the moisture content of the carrots (70-80%) depending on the freshness of the carrot. Thus, it cannot be said that the event of drinking was related to the difference in the device used.

Statistically, the average number of exploratory events was consistently greater for the Raddle as compared to the Challenger Ball®. This may be attributed to the design of the enrichment devices. Treat removal from the Challenger Ball® was significantly easier than treat removal from the Raddle, since not only was the treat visible, but it could be easily grasped through the holes in the Challenger Ball®.

In contrast, the Raddle required substantial manipulation to get the carrot lined up with the body, in order to obtain the treat. Further, the opacity of the material also made it difficult for the primate to see the treat inside, therefore providing extended enrichment. Finally, the design of the Raddle made it impossible for the primate to grasp or touch the carrot contained therein. Because the treat was easily removed from the Challenger Ball®, the primates returned to their normal activity sooner, thereby reducing the desired beneficial activities sought through introduction of the devices. One example of this can be seen in that grooming events were statistically three times higher when the Challenger Ball® was used as an enrichment device as compared to the Raddle.

The Raddle statistically held the primates' interest for a longer period of time as revealed in the Exploratory Events over Time and observed between the 11:00 am and 3:00 pm data collection. Both the Raddle and Challenger Ball® were appealing to primates of a wide age range. Primates involved in this study ranged from yearling to geriatric adult. No statistical difference was noted between primates of varying ages.

Both enrichment devices were easily sanitized through use of a rack washer (180° F.). The durability of the Raddle was tested by autoclaving it twice at 220° F., under 15-18 psi for a 20 minute cycle. No structural changes to the Raddle through exposure to this force were noted.

What is claimed is:

1. A device for enhancing environmental enrichment of primates comprising:
a. A hollow head portion having at least one entry port in communication with an open interior region; and
b. An elongated body portion having a first opening, a second opening and a hollow interior therebetween, wherein said first opening is in communication with said entry port.

2. The device of claim 1, wherein said second opening is sized to allow the insertion of a piece of food therein.

3. The device of claim 2, wherein said piece of food may be directed through said hollow interior of said elongated body portion into said interior region of said hollow head portion.

4. The device of claim 3, wherein said piece of food may be elongated in shape.

5. The device of claim 1, wherein said device is formed from plastic.

6. The device of claim 1, further comprising a plurality of openings on said hollow head portion.

7. The device of claim 1, wherein said device is sized so that said primate may hold said device in its hand.

8. A method of enhancing environmental enrichment of primates, comprising the steps of:
a. Providing a device for enhancing environmental enrichment of primates, said device comprising:
i. A hollow head portion having at least one entry port in communication with an open interior region; and
ii. An elongated body portion having a first opening, a second opening and a hollow interior therebetween, wherein said first opening is in communication with said entry port;
b. Presenting said device to at least one primate; and
c. Allowing said primate to manipulate said device.

9. The method of claim 8, wherein prior to said step of presenting said device to at least one primate, a piece of food is inserted into said interior region of said hollow head portion.

10. The method of claim 9, wherein said piece of food is an elongated piece of food.

11. The method of claim 10, wherein said elongated piece of food is selected from the group consisting of carrots, peppers, unshelled peanuts, and combinations thereof.

12. The method of claim 8, wherein said device is about 6 to about 8 inches in length.

13. The method of claim 8, wherein said step of allowing said primate to manipulate said device includes allowing said primate to perform at least one of the actions selected from the group consisting of holding said device, touching said device, moving said device, smelling said device, shaking said device, and combinations thereof.

14. The method of claim 8, further comprising the step of:
d. monitoring said manipulation of said device.

15. The method of claim 14, wherein said step of monitoring said manipulation of said device comprises monitoring the actions taken by said primate with respect to said device.

16. The method of claim 8, further comprising the step of:
d. monitoring the actions of said at least one primate.

17. The method of claim 16, wherein said step of monitoring the actions of said at least one primate comprises monitoring social actions taken by said primate.
